(19) United States
(12) Patent Application Publication
(10) Pub. No.: US 2011/0075199 A1
(43) Pub. Date: Mar. 31, 2011

(54) IMAGE FORMING APPARATUS AND MULTI-JOB METHOD THEREOF

(75) Inventors: Seok-woo JUNG, Seongnam-si (KR); Sang-hyun Park, Suwon-si (KR)

(73) Assignee: Samsung Electronics Co., Ltd., Suwon-si (KR)

(21) Appl. No.: 12/778,259

(22) Filed: May 12, 2010

(30) Foreign Application Priority Data
Sep. 28, 2009 (KR) 10-2009-0092073

(51) Int. Cl. G06F 3/12; G06K 9/18

(52) U.S. Cl. 358/1.15; 382/182

(57) ABSTRACT

A multi job performing method of an image forming apparatus which includes a document feeder which loads and feeds a plurality of documents and an operation panel which is used to set a job option includes loading the documents on the document feeder to separate the documents according to an orientation of the documents, setting multi-job options corresponding to the documents from the operation panel, scanning the loaded documents, separating multiple jobs according to the orientation of the scanned documents, and performing the multiple jobs according to the multi-job options corresponding to the separated multi jobs. The image forming apparatus and the multi-job operation method separately performs multiple jobs by using an orientation of a document loaded to a paper without an additional prior operation.

### CROSS-REFERENCE TO RELATED APPLICATIONS

This application claims priority under 35 U.S.C. §119 of Korean Patent Application No. 10-2009-0092073, filed on Sep. 28, 2009, in the Korean Intellectual Property Office, the disclosure of which is incorporated herein by reference in its entirety.

### BACKGROUND

1. Field of the Invention

The present general inventive concept relates to an image forming apparatus and a method of performing a multi-job operation of the image forming apparatus, and more particularly, to an image forming apparatus that performs separate operations for each job of a multi-job operation.

2. Description of the Related Art

An image forming apparatus forms an image on a print paper. The image forming apparatus may include a printer, a photocopier, a facsimile, a multi-function device which has at least two functions, etc.

Recently, demand for an image forming apparatus as an office automation device performing not only a document print function but also a scanning function and faxing function has increased. Accordingly, the image forming apparatus has extended its original functions to perform various functions.

In this regard, a user may desire to complete multiple jobs corresponding to a plurality of functions of the image forming apparatus.

For example, if a user desires to copy a five-page document and fax five sheets of paper, the user will load a total of ten sheets of paper on an automatic document feeder (ADF), and the image forming apparatus needs to separate the pages corresponding to the copying job and the faxing job.

In a conventional image forming apparatus, a pre-designated separation page may be inserted between pages to separate jobs.

However, the foregoing method requires a user to preset the separation page to be recognized by the image forming apparatus. This may cause inconvenience for a user.

Further, upon occurrence of errors during the reading or identifying the separation page, the image forming apparatus may have malfunction with respect to the entire multi-job operation.

### SUMMARY

Accordingly, it is a feature of the present general inventive concept to provide an image forming apparatuses and a method to perform a multi-job operation of the image-forming apparatus to perform separate operations corresponding to the separate jobs by using an orientation of a document loaded on a document feeder.

Also, it is another feature of the present general inventive concept to provide an image forming apparatus and a multi job performing method thereof which uses an orientation of a document in separating jobs and has less error than using a separate page.

Additional aspects and/or advantages of the present general inventive concept will be set forth in part in the description which follows and, in part, will be obvious from the description, or may be learned by practice of the present general inventive concept.

Additional aspects and utilities of the present general inventive concept will be set forth in part in the description which follows and, in part, will be obvious from the description, or may be learned by practice of the general inventive concept.

The foregoing and/or other features and utilities of the present general inventive concept may be achieved by a multi-job operation method of an image forming apparatus which includes a document feeder which loads and feeds a plurality of documents and an operation panel which is used to set a job option, the method including loading the documents on the document feeder to separate the documents according to an orientation of the documents, setting multi-job options corresponding to the documents from the operation panel, scanning the loaded documents, separating the documents into multiple jobs according to the orientation of the scanned documents, and performing multiple operations corresponding to the multiple jobs.

Separating the documents into multiple jobs may include separating the documents into jobs by using a width and a height of the scanned documents.

Separating the documents into multiple jobs may include recognizing a job as the same as a previous job if the orientation of a scanned document is not different from that of the previous document.

Separating the documents into multiple jobs may include recognizing an orientation of a text by using an optical character recognition (OCR) for the scanned document, and separating the documents into jobs according to the recognized orientation of the text.

Setting the multi-job operation options may include setting a different operation for each different orientation of the documents.

The method may further include displaying the multi-job operation result on the operation panel.

Performing the multi-job operation may include comparing the number of separated jobs and the number of set job options and notifying a user of a difference between the number of separated jobs and the number of set job options if there is a difference therebetween.

Performing the multi-job operation may further include revising one of the number of jobs and the number of set job options if there is a difference therebetween.

Performing the multi-job operation may include revising the set job option if the job having the job option set is yet to be performed.

The job may include performing at least one of copy, fax, scan-to-email, scan-to-host, scan-to-server, scan-to-HDD, and scan-to-USB operations.

Features and/or utilities of the present general inventive concept may also be achieved by an image forming apparatus connected with an external device, the image forming apparatus including a document feeder which separately loads a plurality of documents according to an orientation of the documents, an image scanner which scans the loaded documents, an operation panel which includes a display panel including a touch panel to select a multi-job operation mode and a user input unit to set multi-job operation options in the multi-job operation mode by using the touch panel of the display unit, and a controller which controls the image scanner to scan the loaded documents, separates jobs of the multi-job operation according to the orientation of the scanned documents, and performs the operations of the multiple jobs according to the multi-job operation options corresponding to the separated jobs.

The controller may separate the jobs by using a width and a height of the scanned documents.

The controller may recognize a job as the same as that of a previous document if the orientation of a scanned document is not different from that of a previous document.

The controller may recognize an orientation of a text by using an optical character recognition (OCR) with respect to the scanned documents and may separates the job by using the recognized orientation of the text.

The operation panel may be used to set each job option for each orientation of the document.

The operation panel may display results of the multi-job operation.

The controller may compare the number of the separated jobs of the multi-job operation and the number of jobs set in the multi-job operation options and may control the operation panel to notify a user of a difference between the number of the separated jobs and the number of the set job options if there is a difference therebetween.

If there is difference between the number of the separated jobs and the number of the set job options, one of the number of the jobs and the number of the job options may be revised according to a user's selection.

If the job having the job option set is yet to be performed, the set job option may be revisable.

The image forming apparatus may further include a communication unit which includes at least one of a fax communication module to transmit the scanned document by fax, a network communication module communicating with an external device or an interface which is compatible with a hard disk drive (HDD) or a universal serial bus (USB), wherein the job includes at least one of copy, fax, scan-to-email, scan-to-host, scan-to-server, scan-to-HDD and scan-to-USB jobs.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1A is a block diagram of an image forming apparatus according to an exemplary embodiment of the present general inventive concept;

FIG. 1B is a block diagram of an image forming apparatus according to another exemplary embodiment of the present general inventive concept;

FIGS. 2A-2C illustrate a job performance in a multi-job operation mode of the image forming apparatus according to the present general inventive concept;

FIGS. 3 to 14 illustrate user interface (UI) screens in the multi-job operation mode according to an exemplary embodiment of the present general inventive concept; and

FIGS. 15A and 15B are flowcharts which illustrate a multi-job operation method of the image forming apparatus according to an exemplary embodiment of the present general inventive concept

FIG. 16 illustrates a document rotating method according to an embodiment of the present general inventive concept; and

FIG. 17 illustrates an image-forming apparatus according to an embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

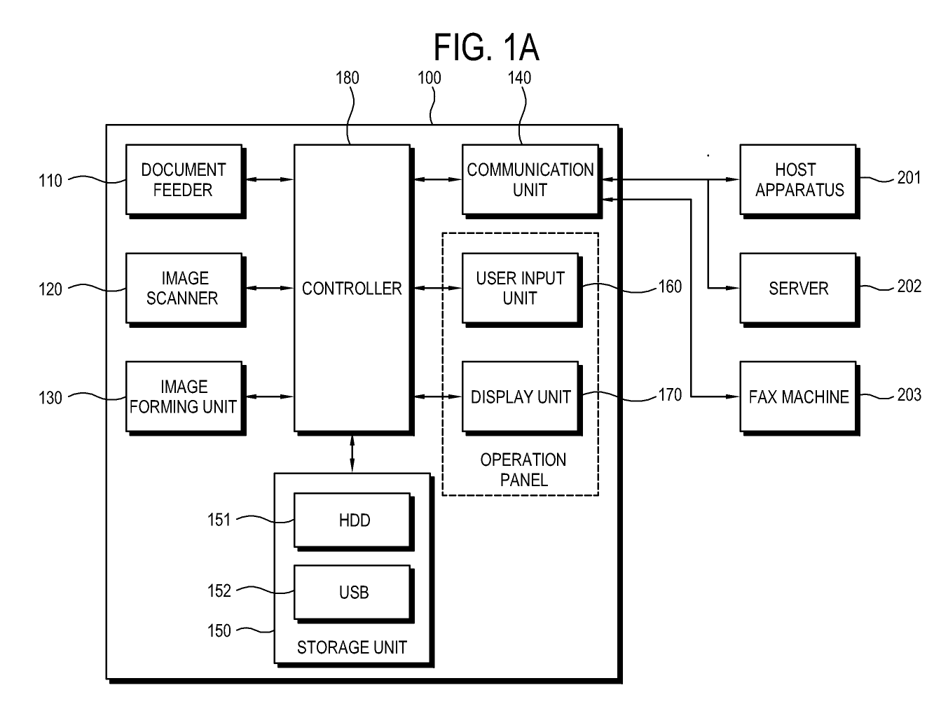

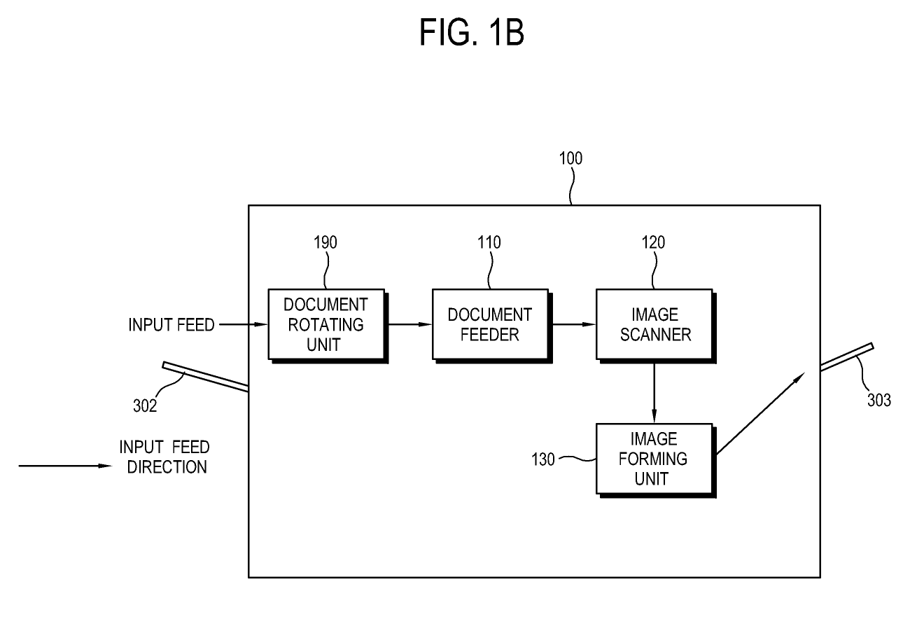

FIG. 1A is a block diagram of an image forming apparatus 100 according to an exemplary embodiment of the present general inventive concept. The image forming apparatus 100 according to the present general inventive concept may include a printer, a photocopier, a scanner, a facsimile, a multi-function device which has at least two functions, etc.

The image forming apparatus 100 according to the present general inventive concept may scan and generate an image from a target document, and perform imaging operations such as copying, faxing, scan-to-server operations, and scan-to-email operations by using the generated image.

In this specification and claims, a generated image is an image that is converted into a form to be stored electronically, displayed electronically, or displayed on a recording medium such as paper. A scanner may scan a document to generate an image of the document, and the generated image may then be printed, transmitted to memory, transmitted to an external device, etc.

In this specification and claims, a “job” is the execution of one or more functions of an image-forming apparatus on a document. A “function” is a specific operation such as scanning, copying, faxing, or sending-to-email, etc. The term “operation,” on the other hand, is described broadly to include an execution of one or more functions and/or one or more jobs. For example, if an image-forming apparatus performs imaging functions x, y, and z, a single job may include performing function x on document A, or performing functions x and y on document A. The combination of one or more functions performed on the document determines the “job.” The image-forming apparatus may perform multiple jobs by performing function x on document A and function x (or y or z) on document B. A multi-job operation may include an operation to automatically perform at least one function on at least two separate documents, for example.

A “document,” for the purposes of the present specification, is a group of one or more recording media that receive the same function or functions in a single operation of the image-forming apparatus. A “document” may refer to paper or other physical media to receive a printed image. A “document” may also refer to electronic data corresponding to a fax, transmitted image, or transmitted file capable of being formed into an image by the image-forming apparatus. For example, if the document is a paper document, it may include multiple pages from multiple sources, and it may have multiple imaging functions performed on it. A user may control the image-forming apparatus to perform one or more functions on a first document. A (which would constitute a first “job”). Once the function or functions are entered or completed, the user may control the image-forming apparatus to perform one or more functions on a second document B (which would constitute a second “job”).

The image forming apparatus 100 according to an exemplary embodiment of the present general inventive concept has a multi-job operation mode to perform multiple jobs by executing a single operation command. If a user selects the multi-job operation mode, the image forming apparatus 100 performs the separate functions associated with the separate jobs according to an orientation of a document loaded on a paper feeding tray.

The image forming apparatus 100 illustrated in FIG. 1A includes a document feeder 110, an image scanner 120, an image forming unit 130, a communication unit 140, a storage unit 150, a user input unit 160, a display unit 170, and a controller 180.

The document feeder 110 includes at least one paper feeding tray to receive a document, such as a recording medium or paper, to print an image. The paper feeding tray may include an automatic document feeder (ADF), a duplex automatic document feeder (DADF), a paper feeding cassette, a manual paper feeding tray, an optional tray, etc. depending on the document supplying method.

The document feeder 110 may further include a pickup roller (not shown) to pick up a recording medium from the paper feeding tray.

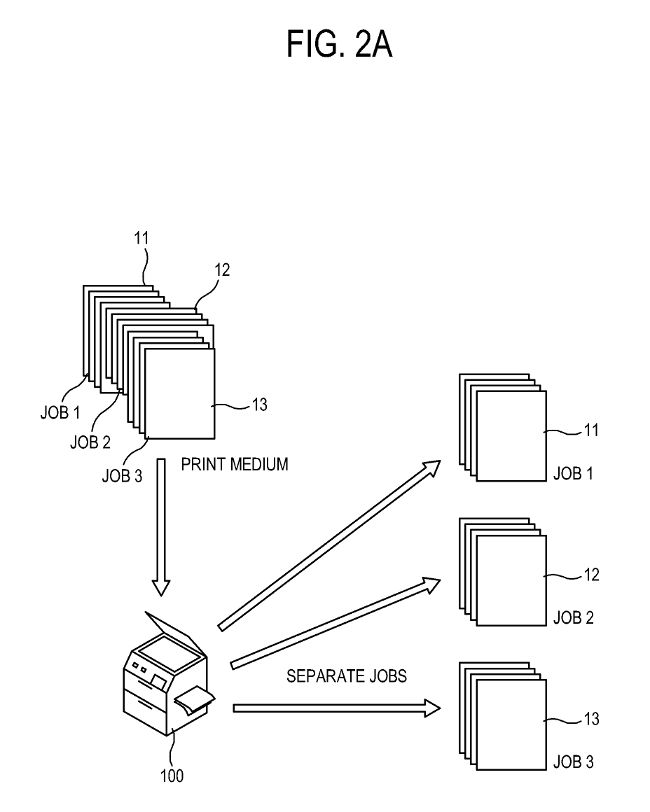

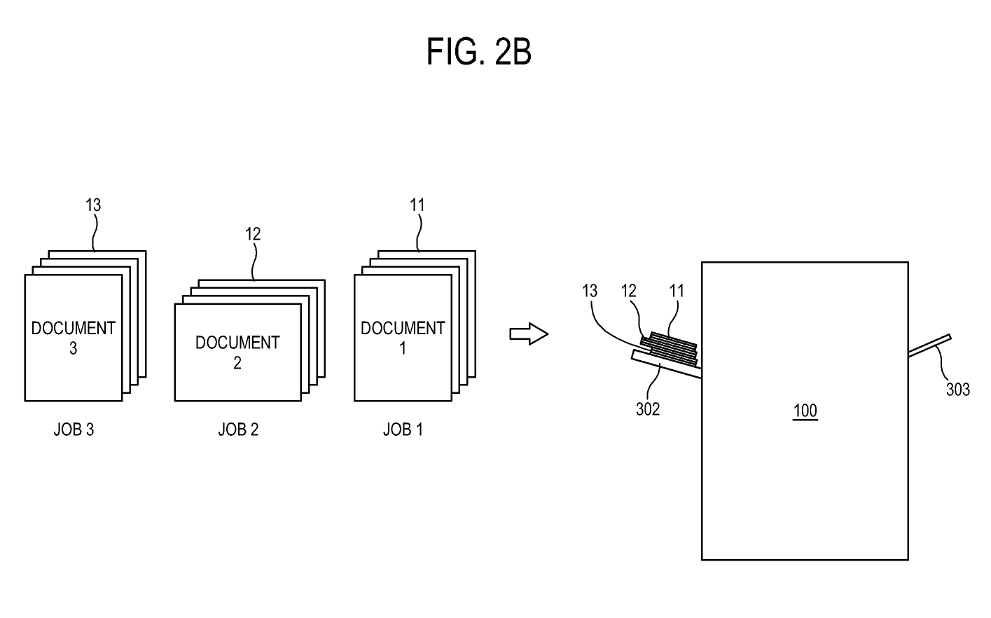

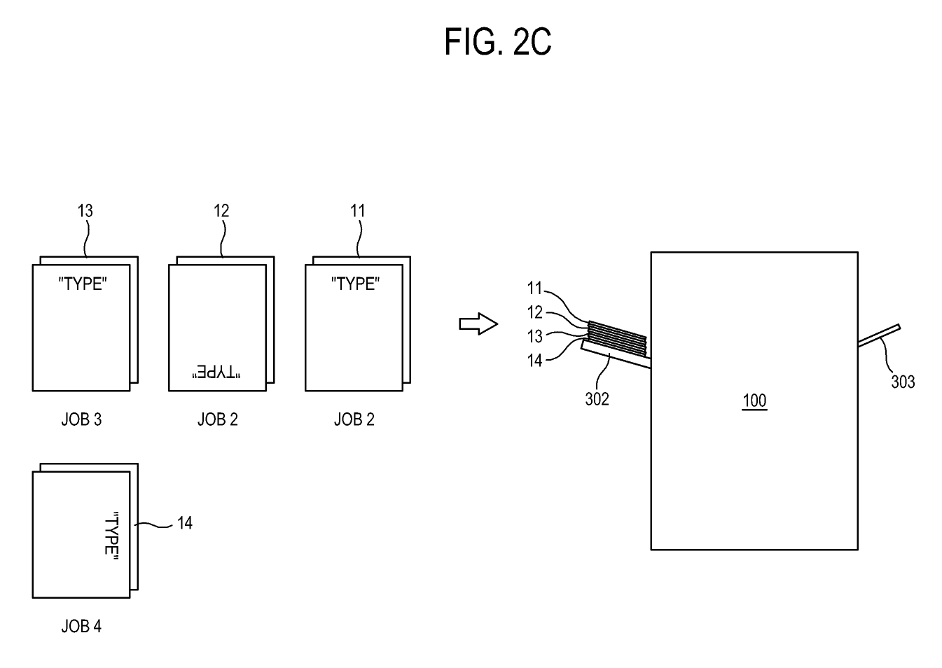

FIG. 2A illustrates operation of the image forming apparatus 100 in a multi-job operation according to the present general inventive concept.

As illustrated in FIG. 2A, if the multi-job operation mode is selected, the image forming apparatus 100 according to the present general inventive concept may load documents 11, 12, and 13 from the paper feeder 110 after a user changes a direction or orientation of the documents 11, 12 and 13 to perform multiple jobs (job 1, job 2 and job 3). The image-forming apparatus 100 separates the papers that comprise the multiple jobs into separate groups corresponding to the respective jobs (job 1, job 2 and job 3) by recognizing the orientation of the loaded documents 11, 12 and 13, and then the image-forming apparatus 100 performs the respective imaging functions corresponding the separate documents 11, 12 and 13.

The image forming apparatus 100 according to the present general inventive concept may load the documents 11, 12, and 13 on the ADF or the DADF after rotating the orientation of the documents 11, 12 and 13 by 90 degrees corresponding to the multi jobs (job 1, job 2 and job 3), or a user may rotate the documents 11, 12, 13 manually. As illustrated in FIG. 1B, the image-forming apparatus 100 may include a document rotating unit 190 to receive pages and to rotate the pages when the user indicates that a completed job has been placed on or in the document rotating unit 190. The user may then place a new set of pages repeat the process. Once the user has placed all the desired pages onto the document rotating unit 190, the user may select a multi-job operation, and the image-forming apparatus 100 may perform imaging functions on the respective jobs according to the rotated orientation of the respective jobs.

FIG. 1B further illustrates that the input feed direction of the image-forming apparatus and method corresponds to a direction in which a page may be fed into the image-forming apparatus. Although the input feed direction is illustrated with respect to a side of the image-forming apparatus 100, the input feed direction may be any direction, depending on the particular configuration of the image-forming apparatus 100. In other words, the input feed direction refers to a direction in which a document is fed into an image-forming apparatus 100 and may be different for each image-forming apparatus 100.

FIG. 2B illustrates an expanded view of the orientation of the jobs 1, 2, and 3 corresponding to the documents 11, 12, and 13. A user may rotate a document by ninety degrees with respect to a subsequent document to indicate that the documents correspond to separate jobs. The user may place the documents 11, 12, and 13 having different orientations onto the feeder tray 302. When a user indicates a multi-job operation, the image-forming apparatus 100 may intake a page of the document 11 to determine an orientation of the page. The image-forming apparatus may intake a second page and compare the orientation of the second page with the first page. If the orientation of the second page is the same as that of the first page, the image-forming apparatus 100 may determine that the pages belong to the same job. If the orientation of the second page is different than that of the first page, the image-forming apparatus 100 may determine that the second page belongs to a new job and may begin a new imaging function on the second page that may be different than the imaging function performed on the first page. When the image-forming apparatus 100 detects a job based on an orientation of the respective document, 11, 12, or 13, the image-forming apparatus 100 may not determine an orientation of a type on the respective document 11, 12, or 13.

The image forming apparatus 100 may also load the documents 11, 12, and 13 by rotating the orientation of the documents 11, 12, and 13 by 180 degrees corresponding to the respective jobs (job 1, job 2 and job 3). If the orientation of the documents 11, 12, and 13 is rotated by 180 degrees, the image forming apparatus 100 recognizes the orientation of the documents by using a character read by an optical character recognition (OCR). If the orientation of the recording medium is rotated by 90 degrees, the OCR may be used to read the character as the case may be. The optical character recognition may be a device included in the image forming apparatus 100 or it may include a computer program stored in the storage unit 150 or other memory of the image forming apparatus 100 to analyze the image scanned by the image scanner 120 or received from the communication unit 140. If the OCR device is a stand-alone device, it may include one or more inputs such as an optical input or an electrical connection to receive an electronic image signal.

FIG. 2C illustrates an expanded view of the orientation of the jobs 1, 2, 3, and 4, corresponding to documents 11, 12, 13, and 14, respectively. A user or a document rotating unit 190 may rotate a document so that a text direction is rotated by 90 or 180 degrees with respect to a subsequent document. For example, in FIG. 2C, document 12 is rotated 180 degrees with respect to document 11, because the text of document 12 is rotated 180 degrees with respect to document 11. In addition, document 14 is rotated 90 degrees with respect to document 11, because the text direction of document 14 is rotated 90 degrees with respect to the text direction of document 11.

The image-forming apparatus may intake a page of a document and the optical character recognition unit may determine an orientation of the text of the page. If the orientation of the text is the same as that of the previous page, the image-forming apparatus may determine that the page is part of a same job as the previous page. If the orientation of the text is rotated 90 or 180 degrees with respect to the text of the previous page, the image-forming apparatus 100 may determine that the page is part of a new job, and may execute an imaging function on the new page that may be different than the function executed on the previous page.

When the image-forming apparatus 100 determines an orientation of the text of a page, multiple pages having different physical orientations may be included in the same job, as long as the orientation of the text of each page is the same. The image-forming apparatus 100 may be programmed to detect only a line of text at a top of each page to determine page orientation, or the image-forming apparatus 100 may determine a text orientation of any portion of the page.

The documents 11, 12, and 13 which are loaded on the document feeder 110 may be different in size. For example, three types of documents, e.g., A4, letter size and A3 may be rotated by 90 or 180 degrees depending on the type of jobs to be loaded on the ADF.

The image scanner 120 scans a target document to generate an image. The image may be printed onto a recording medium, such as paper or a transparency, or it may be saved as an electronic file. The target document may include a text document, a photo, a film, etc. The image scanner 120 may include a scan unit to generate an image, one or more processors, memory, logic circuits, power supplies, or other hardware to support the scanning function.

The image which is scanned by the image scanner 120 may be converted into an electronic file to be transmitted via a fax signal to an external device via the communication unit 140 (to be described later).

Upon reception of a print command, the image forming unit 130 forms an image to be printed on at least one recording medium, such as paper, based on print data. In the present specification and claims, a “print command” and “print operation” refer to any operation to transmit an image to a recording medium, including printing received fax data, copying or printing a scanned document, and printing data received from a host apparatus 201 including a server 202 external to the image forming apparatus 100, from a data storage device such as the USB memory stick 152 external to the image forming apparatus 100, or from a data storage device such as the hard disk drive 151 located inside the image forming apparatus 100.

The communication unit 140 performs data communication with external devices including the host apparatus 201 and the server 202 connected in a wired/wireless network and receives print data in a predetermined print language from external devices.

The communication unit 140 may include a wired or wireless communication module connected to an external device such as the host apparatus 201 either directly via a dedicated communication line, via a network utilizing a predetermined protocol, or via an interface (e.g., USB port) which is compatible with an interface connectable to a portable storage medium such as a USB memory stick or an interface which is connected with the HDD 151.

The communication unit 140 may include a fax communication module (e.g., modem) which converts image data generated by the image scanner 120 into a fax signal and transmits the fax signal to an external fax machine 203 (including a multi-function device to perform a fax function) or receives a fax signal from the outside.

The communication unit 140 may perform a scan-to-host operation or a scan-to-server operation to transmit a scan image to an external device such as the host apparatus 201 or the server 202 by a predetermined protocol or may transmit the scan image to an external device via a scan to email operation.

Data (including fax data) which are received from external devices via the communication unit 140 are stored in the storage unit 150.

The storage unit 150 stores therein various print data for a print job, fax data for a fax transmission job, image data scanned by the image scanner 120, data received from external devices connected through the communication unit 140, various setting information of the image forming apparatus 100 through the user input unit 160, job history information for multi-job operations of the image forming apparatus 100, user registration information set for each user account, user certification information, and usage authorization information.

The storage unit 150 includes an internal storage medium such as the HDD 151, or an external or portable storage medium such as the USB memory stick 152, a memory card (memory stick, CF card and MMC), and a memory card slot.

The user input unit 160 receives a user's command. The user input unit 160 may include an input button (“hard key”) provided in the image forming apparatus 100, or a graphic user interface (GUI) which is generated by an execution of a program such as an application and displayed on the display unit 170 to receive a user's input by a touch.

A user may perform a login process in which an ID and a password assigned to each user account are input through the user input unit 160. The login may include a login to an administrator mode in which the entire environment of the image forming apparatus 100 may be set or changed without an additional access limit. If the login to a user mode or an administrator mode is performed, the image forming apparatus 100 performs identification and permission processes. A user according to the present general inventive concept may include an administrator.

A user's command may be received from the host apparatus 201 which is connected to the image forming apparatus 100 through the communication unit 140.

The display unit 170 may display thereon setup and operation statuses of the image forming apparatus 100 and a UI screen to receive various commands from a user. The display unit 170 may include a thin film transistor-liquid crystal display (TFT-LCD), a driver (not shown) to drive the TFT-LCD, and a touch panel (“touch screen” or “touch pad”) to recognize a user's touch.

The user input unit 160 of the image forming apparatus 100 according to the present general inventive concept may include an icon to be selected by a user through a touch panel of the display unit 170. That is, the user input unit 160 and the display unit 170 may be a single device, instead of being provided separately.

The single configuration of the user input unit 160 and the display unit 170 of the image forming apparatus 100 according to the present general inventive concept is also called an operation panel.

The display unit 170 may include a first display unit located in the image forming apparatus 100, and a second display unit which is located in the host apparatus 201 connected to the image forming apparatus 100 via the communication unit 140. If the display unit 170 includes the second display unit, a UI which is displayed as the user input unit 160 on the second display unit may include a remote user interface (RUI).

The controller 180 controls the image forming apparatus 100 as a whole. More specifically, upon reception of multi-job commands from the user input unit 160, the controller 180 may recognize the direction, i.e., the orientation of the documents 11, 12 and 13 (refer to FIG. 2) loaded on the document feeder 110 corresponding to multiple jobs and may control the separate operations performed on the documents 11, 12, and 13 corresponding to the separate jobs.

When a multi-job operation includes a scanning operation, the multi-job operation may include at least one of copying, faxing, scanning to a server, scanning to a host, scanning to email, scanning to an HDD, and scanning to a USB device or port.

The user input unit 160 may include an icon which is displayed as a UI on the display unit 170 to select the multi-job operation mode in which the multiple jobs are performed by a single operation command.

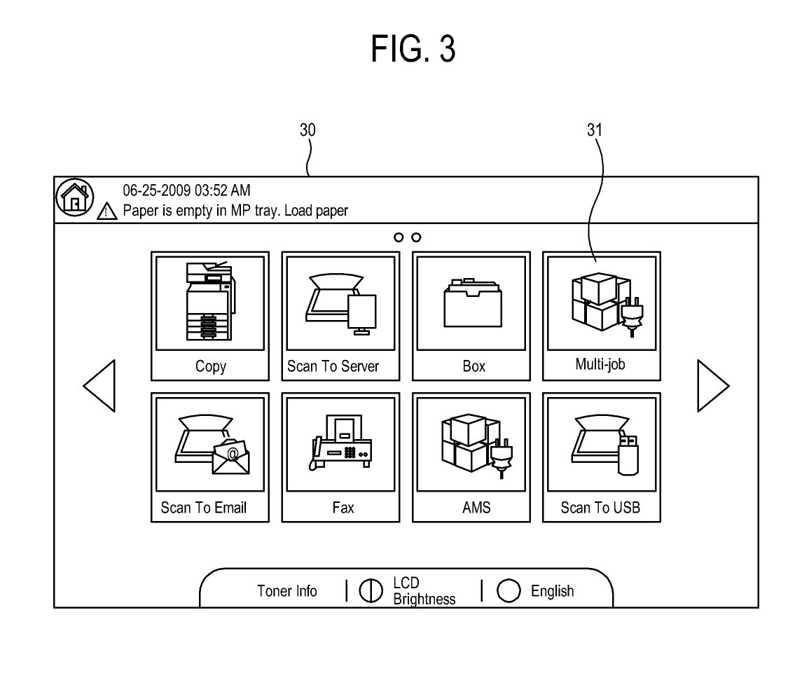

FIGS. 3 to 14 illustrate UI screens in the multi-job operation mode according to the exemplary embodiment of the present general inventive concept.

Referring to FIGS. 3 to 14, an exemplary embodiment to set four jobs to be sequentially performed corresponding to copy, fax, scan-to-server, and scan-to-email operations in the multi-job operation mode will be described.

As illustrated in FIG. 3, the display unit 170 may display thereon a selection screen 30 including an icon corresponding to various menus that a user may select to perform various functions of the multi-function imaging device. Here, a user may select (e.g., touch) a selection icon 31 to perform a multi-job operation by a single job command in the multi-job operation mode.

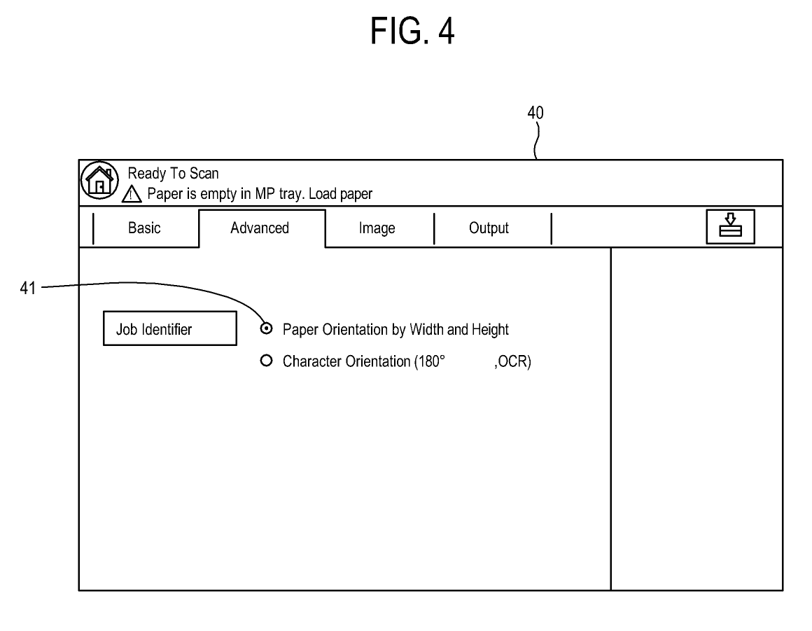

If the multi-job operation mode is selected, the display unit 170 displays a UI screen 40 to allow a user to select a method to separate the multiple jobs, as illustrated in FIG. 4. The UI screen 40 in FIG. 4 may include at least one radio button 41 to select either one of the methods to separate the jobs.

A user may select a width and height ratio of the document to use as the reference to separate multiple jobs, or the user may select a text orientation as determined by an optical character recognition (OCR) to use as the reference to separate the multiple jobs.

Depending on the user selection or upon predetermined configuration settings, the controller 180 may recognize the orientation of the document by using the width and height ratio of an image of a document scanned by the image scanner 120 or by using the orientation of the text read by the OCR to separate the multiple jobs.

If the recognized orientation of a page is the same as that of a previous page, the controller 180 may recognize the pages as being part of the same job. However, if the orientation of a page changes with respect to the orientation of the previous page, the controller 180 may recognize a new job.

If the width and height ratio of the document is used to separate different jobs, the controller 180 recognizes the job as a new job and performs the operation that corresponds to the new job when the controller determines that the orientation of the page is rotated by 90 degrees with respect to the orientation of the previous page.

On the other hand, if the OCR is used to separate different jobs, the controller 180 recognizes the new job and performs the operation corresponding to the new job when the controller 180 determines that the orientation of the text of the page is rotated by 90 or 180 degrees.

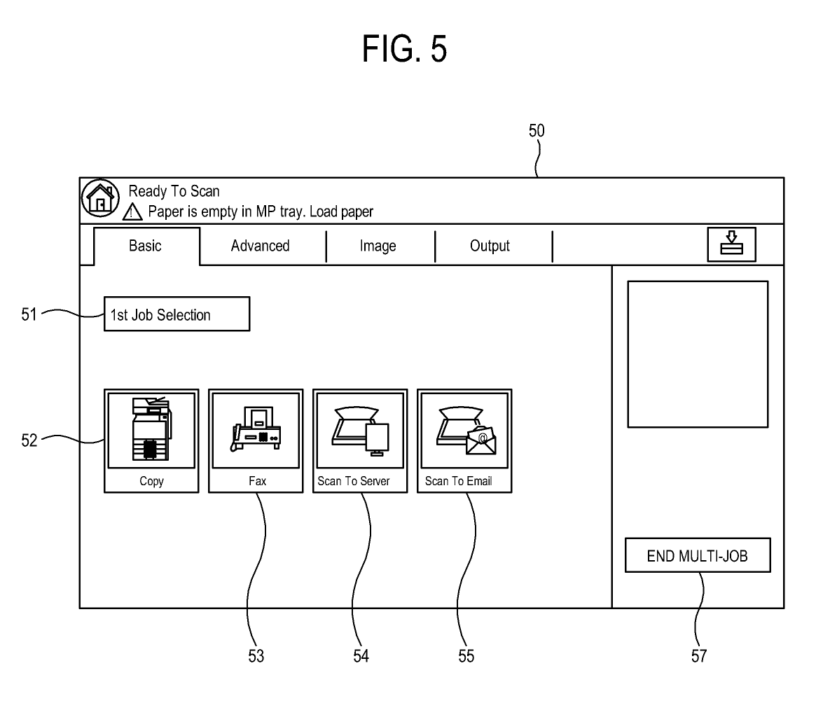

Upon selecting a respective radio button 41 in FIG. 4 to select a method of separating jobs, the display unit 170 displays an option setting screen 50 corresponding to multiple jobs as illustrated in FIGS. 5 to 13.

A user sets job options or settings, or configures respective jobs of the multiple jobs of the multi-job operation as illustrated in FIGS. 5 to 13. A user may set job options by using an operational panel, for example.

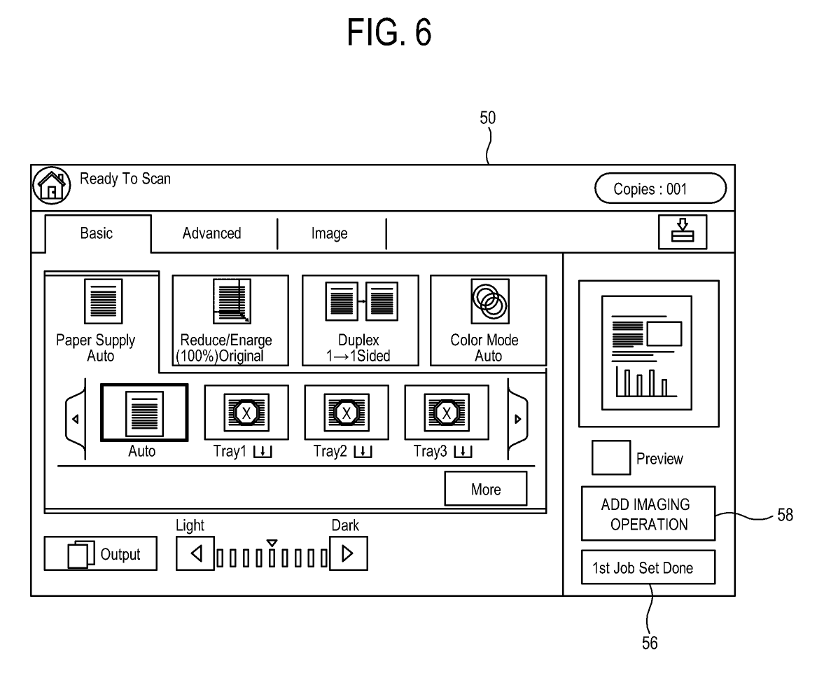

A user may set job options for a first job as shown in FIGS. 5 and 6. The option setting UI screen 50 may include an icon 51 which displays the number of the job presently being configured (being the first job in FIG. 5) and at least one of icons 52, 53, 54, and 55 to select the type of operation to be performed. In FIG. 5, the icons include icons 52, 53, 54, and 55 representing a copy operation, a fax operation, a scan-to-server operation, and a scan-to email operation, respectively. The icon may vary including a text, a graphic and a button or may be enabled as a GUI provided as the user input unit 160 to be selected by a user.

Additional operational icons may further include various job icons including scan-to-host, scan-to-HDD, and scan-to-USB operations or any other operation that may be performed by the image-forming apparatus 100.

The option setting screen 50 may include an “End Multi-Job” icon 57 to terminate the multi-job operation mode. If no job options have been set, the controller 180 may control the display unit 170 to display the UI screen 30 of FIG. 3.

If a user selects the copy icon 52 to perform a copying operation in the first job, the controller 180 may cause the display unit 170 to display the UI screen 50 that is illustrated in FIG. 6.

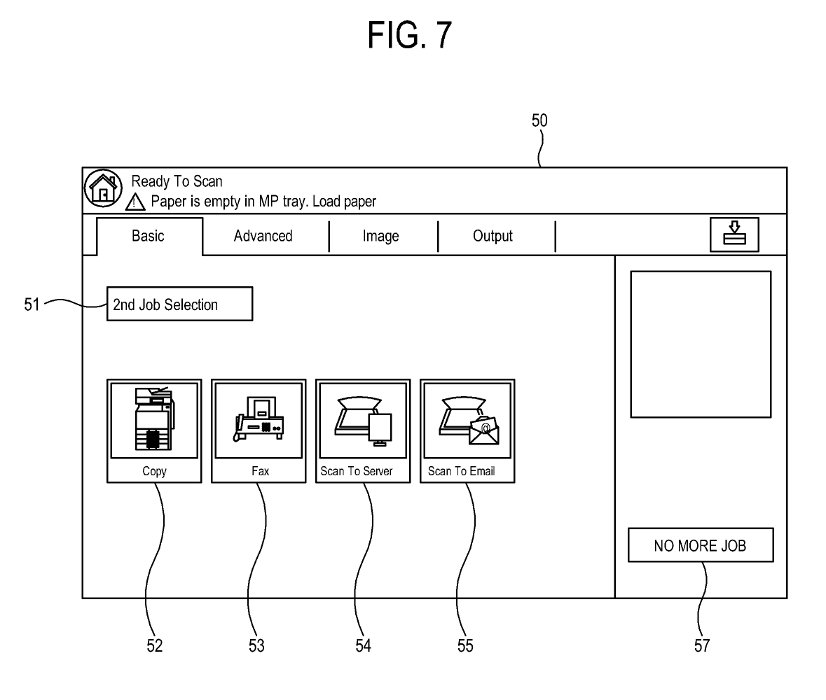

A user may select various options corresponding to the copy job, such as a copy ratio, mono/color, and a contrast, and may select a “1st job set done” icon 56 to complete the setting of the first job. The “1st job set done” icon 56 is illustrated as an example, and any appropriate icon may be used to indicate that a user is finished changing settings of a first job of a multi-job operation. When the user selects the “1st job set done” icon 56, the display unit 170 may display the option setting UI screen 50 as illustrated in FIG. 7.

The option setting screen 50, as illustrated in FIG. 6, may also include an “add imaging operation” icon 58 to allow a user to perform multiple imaging operations in the same job. For example, a single document may be copied and emailed to a predetermined email address in the same job without requiring a user to provide separate documents to the image-forming apparatus 100 to perform the separate operations. In such a case, the controller 180 may cause the display unit 170 to again display the option setting screen 50 illustrated in FIG. 5 to allow the user to select another operation to perform in the same job.

The UI screen 50 illustrated in FIG. 7 may include an icon 51 to display the number of the job being presently configured and at least one of icons 52, 53, 54 and 55 to select the type of operation to correspond to the job. In other words, the UI screen 50 of FIG. 7 may be similar to that of FIG. 5, except that the icon 51 changes to reflect that a new job is presently being configured. As illustrated in FIGS. 5, 7, 9, and 11, the user may repeatedly configure a new job to be performed, and the user may configure the settings of each of operations corresponding to the respective jobs, as illustrated in FIGS. 5, 8, 10, and 12, respectively. In addition, as illustrated in FIGS. 5, 7, 9, and 11, the user may finish configuring new jobs by selecting the “no more jobs” icon 57, although any similar icon may be used to indicate that a user is finished configuring jobs.

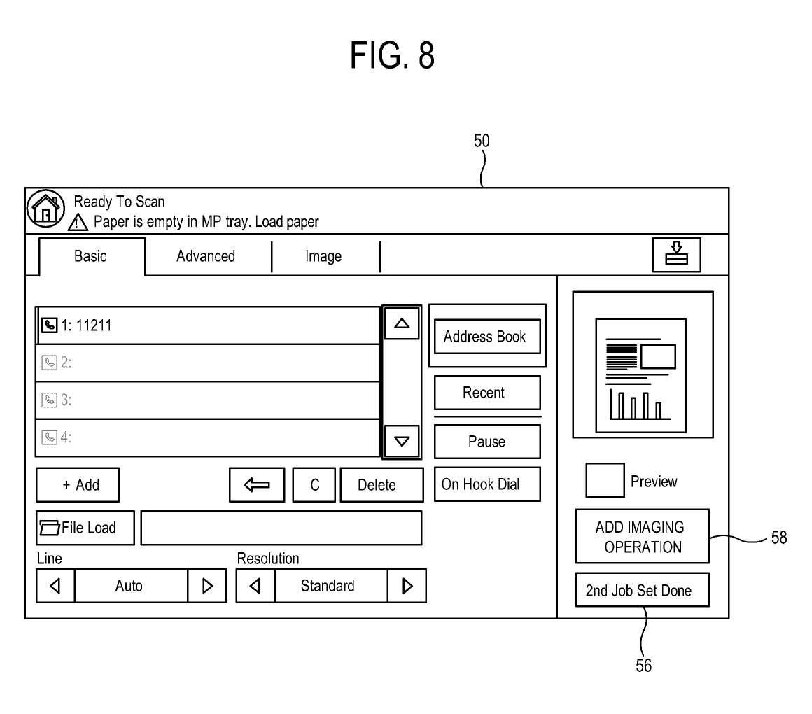

Still referring to FIG. 7, if the user selects the fax icon 53 as the type of the second job, the controller 180 may display on the display unit 170 the UI screen 50 illustrated in FIG. 8.

A user may set various options corresponding to the fax job, such as a recipient, an error correction mode, and the number of retransmission, and the user may select the “2nd job set done” icon 56 to complete the configuration of the settings of the second job. A user may input the recipient by using an address book stored in the storage unit 150, in a recent transmission and reception list, or from any other source.

The option setting screen 50, as illustrated in FIG. 8, may also include an “add imaging operation” icon 58 to allow a user to perform multiple imaging operations in the same job. For example, a single document may be copied and emailed to a predetermined email address in the same job without requiring a user to provide separate documents to the image-forming apparatus 100 to perform the separate operations. In such a case, the controller 180 may cause the display unit 170 to again display the option setting screen 50 illustrated in FIG. 7 to allow the user to select another operation to perform in the same job.

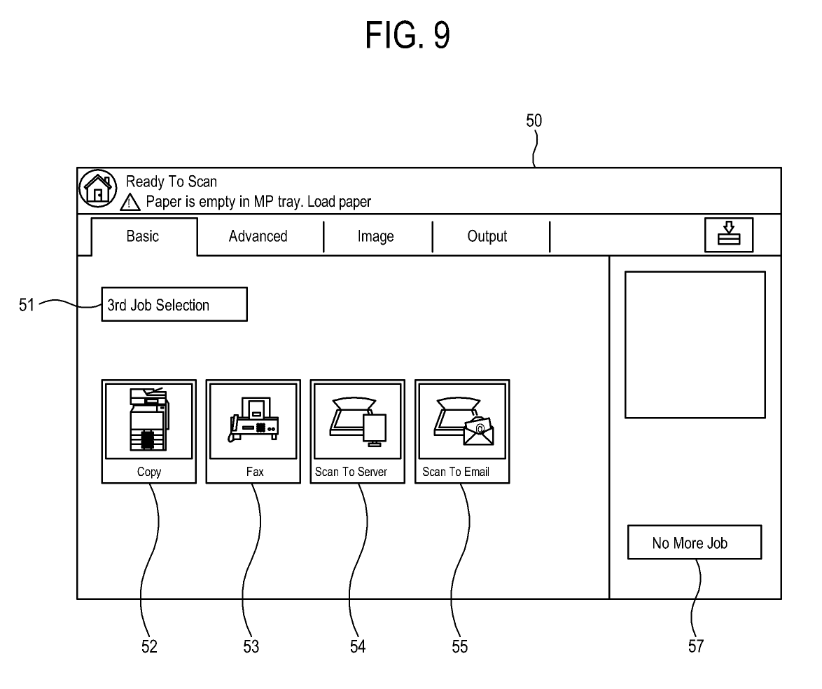

Upon selecting the “2nd job set done” icon 56, the option setting UI screen 50 may again be displayed on the display unit 170, as illustrated FIG. 9. The UI screen 50 in FIG. 9 may be similar to that of FIGS. 5 and 7, except that the icon 51 may indicate that the job presently being configured is the third job. If a user is finished configuring multiple jobs, the user may select the “no more job” icon 57. Alternatively, the user may select another operation icon 52, 53, 54, or 55 to configure the third job.

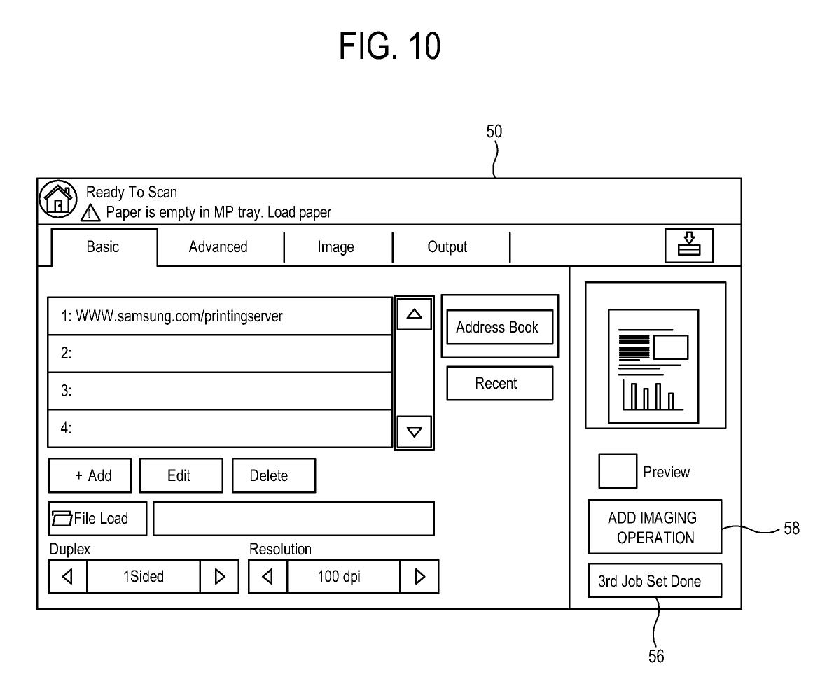

If the user selects the “scan-to-server” icon 54, the controller 180 may cause the display unit 170 to display the UI screen 50 illustrated in FIG. 10. The user may set various options corresponding to the scan-to-server job, such as a location of a server (address), an error correction mode, and the number of desired re-transmission attempts. The user may input the location of the server by using a list of addresses stored in the storage unit 150, by using a “recent usage” list, or by using any other means to retrieve or enter a server location. The user may select a “3rd job set done” icon 56 to finish configuring the third job.

The option setting screen 50, as illustrated in FIG. 10, may also include an “add imaging operation” icon 58 to allow a user to perform multiple imaging operations in the same job. For example, a single document may be copied and emailed to a predetermined email address in the same job without requiring a user to provide separate documents to the image-forming apparatus 100 to perform the separate operations. In such a case, the controller 180 may cause the display unit 170 to again display the option setting screen 50 illustrated in FIG. 9 to allow the user to select another operation to perform in the same job.

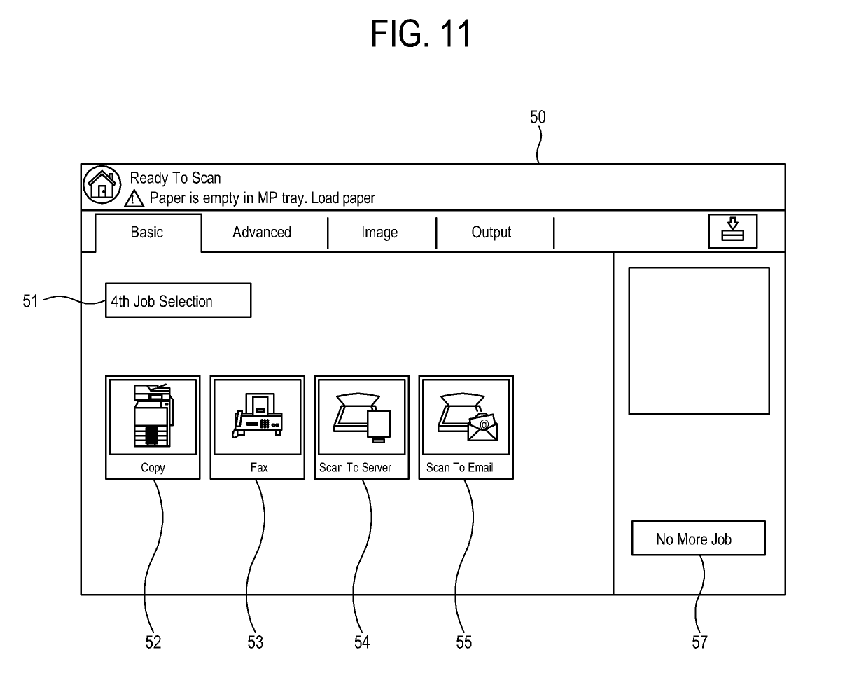

Upon selecting the “3rd job set done” icon 56, the option setting UI screen 50 may again be displayed on the display unit 170, as illustrated in FIG. 11.

The UI screen 50 in FIG. 11 may be similar to that of FIGS. 5, 7, and 9, except that the present job number icon 51 may indicate that the job presently being configured is the fourth job. If a user is finished configuring multiple jobs, the user may select the “no more job” icon 57. Alternatively, the user may select another operation icon 52, 53, 54, or 55 to configure the fourth job.

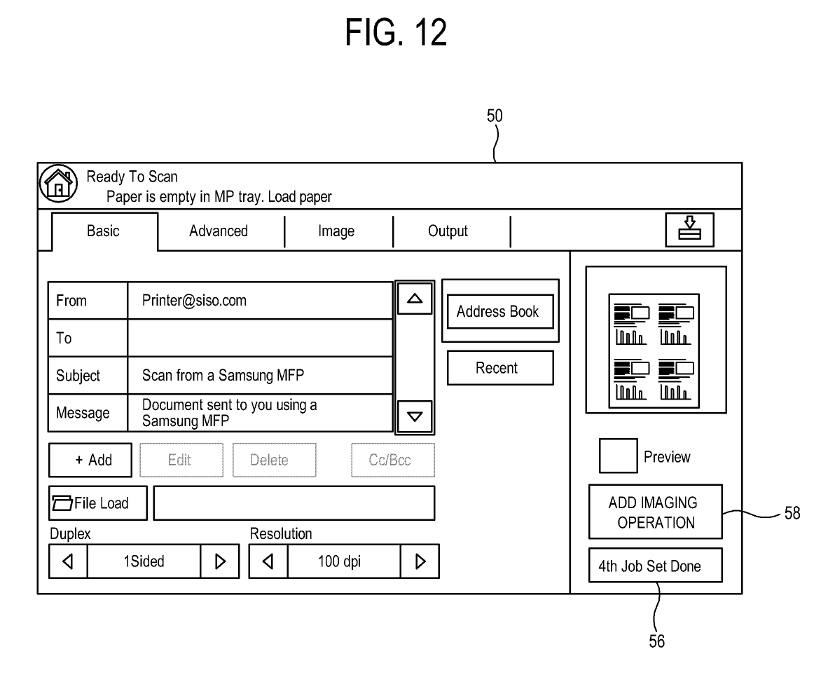

If the user selects the “scan-to-email” icon 55 in FIG. 11, the controller 180 may control the display unit 170 to display the UI screen 50, as illustrated in FIG. 12.

A user may select various options corresponding to the scan-to-email operation, such as information of a sender, information of a recipient, a title, and a message. The user may input the information of the sender and the information of the receiver by using an address book stored in the storage unit 150, information stored in a recent usage list, or information from any other source. The storage unit 150 may store a default value for the information of the sender, the title, and/or the message. When finished configuring the scan-to-email operation, the user may select the “4th job set done” icon 56.

The option setting screen 50, as illustrated in FIG. 12, may also include an “add imaging operation to job” icon 58 to allow a user to perform multiple imaging operations in the same job. For example, a single document may be copied and emailed to a predetermined email address in the same job without requiring a user to provide separate documents to the image-forming apparatus 100 to perform the separate operations. In such a case, the controller 180 may cause the display unit 170 to again display the option setting screen 50 illustrated in FIG. 11 to allow the user to select another operation to perform in the same job.

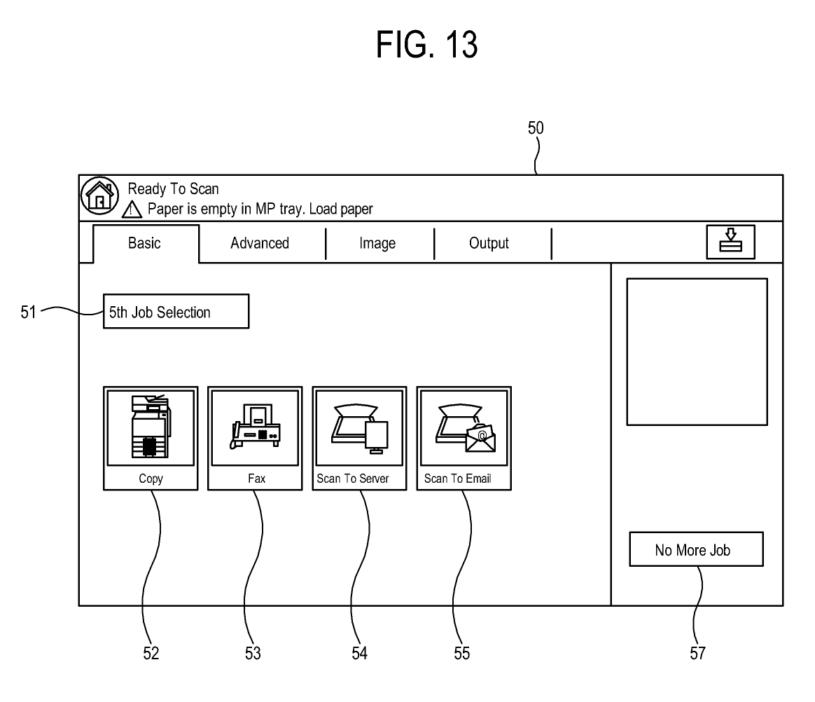

Upon selecting the “4th job set done” icon 56, the option setting UI screen 50 may again be displayed on the display unit 170, as illustrated in FIG. 13.

The UI screen 50 in FIG. 13 may be similar to that of FIGS. 5, 7, 9, and 11, except that the present job number icon 51 may indicate that the job presently being configured is the fifth job. If a user is finished configuring multiple jobs, the user may select the “no more job” icon 57. Alternatively, the user may select another operation icon 52, 53, 54, or 55 to configure the fourth job.

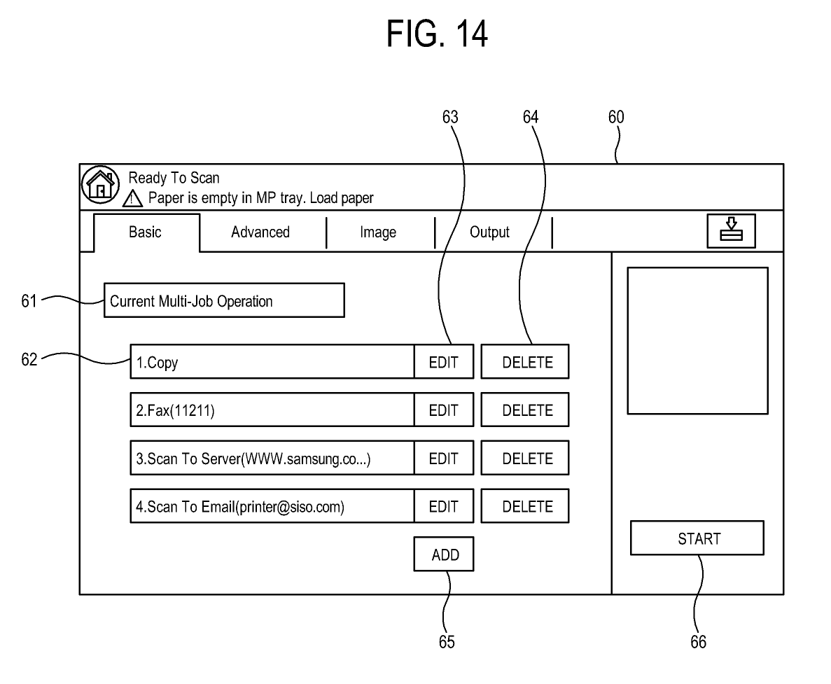

If a user selects the “no more job” icon 57 to complete configuration of the fourth job, the display unit 170 displays a setting result UI screen 60 as illustrated in FIG. 14. The setting result UI screen 60 may include an icon 61 indicating the displayed operations relate to a “current multi-job operation.” The setting result UI screen 60 may also include a list 62 of the individual jobs of the multi-job operation, an edit icon 63, a delete icon 64, an add icon 65, a start icon 66 to begin the multi-job operation, and any other appropriate icons.

A user may review the data illustrated in the setting result UI screen 60 and confirm the number and type of multiple jobs. A user may select the edit icon 63 to edit the job configurations, or the user may select the delete icon 64 to delete the corresponding job from the multiple jobs. A user may select the add icon 65 to add a new job.

If a user selects the add icon 65 in FIG. 14, the display unit 170 may again display the option setting UI screen 50 as illustrated in FIG. 13.

When the user determines that the configuration of the jobs is complete, the user may select the “start” icon 66 to begin the multi-job operation

Accordingly, the image forming apparatus 100 according to the present general inventive concept may perform multiple jobs by a single job command in the multi-job operation mode.

According to the job command received in FIG. 14, the controller 180 may change or rotate the orientation of the documents by 90 or 180 degrees corresponding to the respective separated jobs and may scan and generate an image through the image scanner 120 with respect to the document loaded on the document feeder 110.

The controller 180 may recognize the orientation of the document through the generated image and may separately perform the multiple jobs according to the recognized orientation of the document. The controller 180 may determine the orientation of the document by using the width and height ratio of the scan image or by using the orientation of the document which is recognized by the OCR performed to the scan image.

If the recognized orientation of a page is the same as that of a previous page, the controller 180 may recognize that the pages correspond to the same document and the same job. However, if the controller 180 determines that the orientation of the present page is different than the orientation of the previous page, the controller 180 may determine that the present page is the first page of a new job. The controller 180 may then sequentially perform the respective jobs according to the configurations of the jobs set by the user in FIGS. 3 to 14.

More specifically, the controller 180 controls the image forming unit 130 to perform the copy job for the document corresponding to the first job, controls the communication unit 140 to transmit a fax by changing the scanned image into a fax signal for the document corresponding to the second job rotated 90 or 180 degrees relative to the document for the first job, controls the communication unit 140 to transmit the scanned image to a server corresponding to the third job, and controls the communication unit 140 to transmit an email attached with the scanned image corresponding to the fourth job. Then, the operation panel may display the results of the multi-job operation.

To normally perform multiple jobs in a multi-job operation mode, the number of documents separated by orientation of page dimensions or text should be consistent with the number of configured jobs. However, if the number of documents separated by page or text orientation does not correspond to the number of configured jobs, due to user mistake for example, the controller 180 may control the display unit 170 to notify a user of the discrepancy.

If the number of documents separated by the orientation of the document exceeds the number of configured jobs, the controller 180 may perform a default operation on the extra document, such as scanning the document and saving the document in electronic format onto the hard disk drivel 51. The user may set any operation of the image-forming apparatus 100 to be the default operation. Alternatively, the controller 180 may perform no imaging operation on the extra separated document.

On the other hand, if the number of configured jobs exceeds the number of documents separated by page orientation, the controller 180 may wait to receive an additional document and perform the job corresponding to the additional document, or the controller 180 may cancel the job. For example, if a user configures three jobs in the multi-job operation mode and loads only two separate documents on the document feeder 110, the controller 180 may control the display unit 170 to notify a user of the discrepancy. The display unit 170 may display at least one icon to be selected by a user as an icon to select to load the document or to cancel the third configured job.

If a user selects of the icon to load an additional document, the controller 180 controls the display unit 170 to display a message requesting the loading of the additional document. When the user loads the document on the document feeder 110, the controller 180 performs the third job according to the previously-configured settings of the third job.

On the other hand, if the user selects the icon to cancel the third job, the controller 180 cancels the third job and indicates via the display unit 170 that the multi-job operation is complete.

An exemplary embodiment of the present general inventive concept recognizes the orientation of the document by using the width and height ratio of the document or the orientation of a text recognized by OCR. In addition, any embodiment may be included in the present general inventive concept as long as it can recognize a change in the orientation of the document.

Not only the orientation of the document, but also other separating means using the arrangement of the document, e.g., the case when the documents in different size are loaded, the case when the document is loaded upside down for each job in a duplex automatic document feeder (DADF) or when the document is loaded on different trays may be possible.

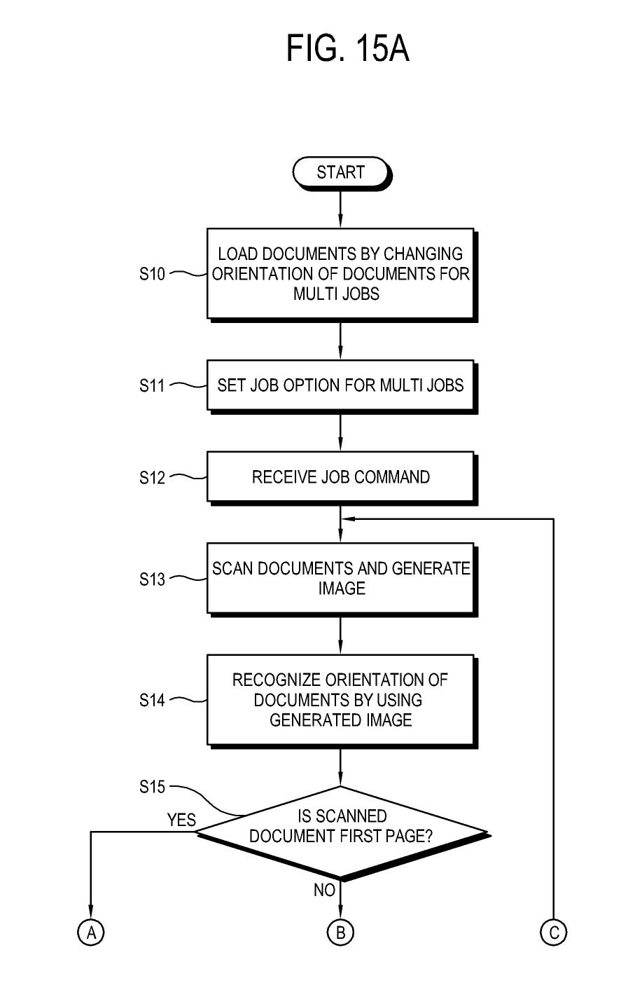

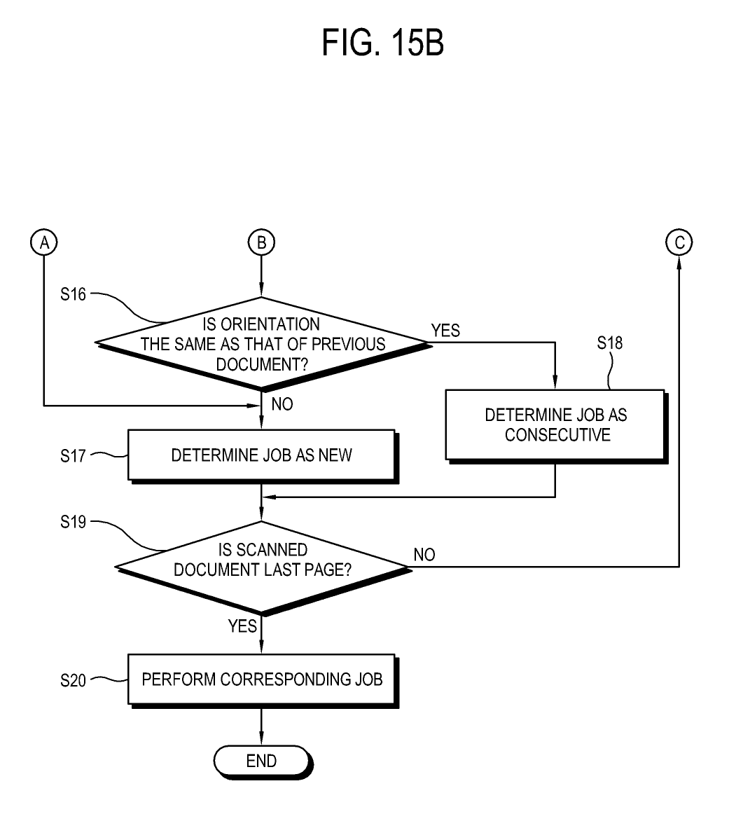

Hereinafter, the job performing process of the image forming apparatus 100 having the foregoing configuration will be described with reference to FIGS. 15A and 15B.

As illustrated in FIG. 15A, a user may load the documents on the document feeder 110 by changing the orientation of the documents for each of the multi jobs (S10). A user may load the documents on the automatic document feeder (ADF) or duplex automatic document feeder (DADF) by rotating the orientation of the documents by 90 or 180 degrees.

A user sets the job option for the multi-job operation (S11). A user may select the multi-job operation mode 31 as in FIG. 3, select the job separating reference 41 in FIG. 4 and set the job option for the multiple jobs as illustrated in FIGS. 5 to 13.

If the document is loaded after the orientation thereof is rotated by 180 degrees at operation S10, a user may select the OCR as the job separating reference 41 in FIG. 4.

If the setting of the job option is completed at operation S11, the image forming apparatus 100 receives a user's job command (S12). A user may select the icon 66 corresponding to the job command from the setting result UI screen 60 in FIG. 14.

In operation S13, if the job command is received at operation S12, the controller 180 scans the first page of the documents loaded on the document feeder 110, and generates the image.

In operation S14, the controller 180 recognizes the orientation of the document by using the image generated at operation S13.

In operation S15, the controller 180 determines whether the document scanned at operation S13 is the first page of the documents loaded at operation S10.

In operation S17, if it is determined that the scanned document is the first page at operation S14, the controller 180 recognizes the job corresponding to the scanned page as a new job, i.e., a job corresponding to the first job set at operation S11.

In operation S19, the controller 180 determines whether the document scanned at operation S13 is the last page of the documents loaded at operation S10.

If it is determined that the scanned page is not the last page at operation S19, the controller 180 scans the second page of the documents loaded on the document feeder 110 and generates the image in operation S13.

In operation S14, the controller 180 recognizes the orientation of the document by using the image generated at operation S13.

In operation S15, the controller 180 determines whether the document scanned at operation S13 is the first page of the documents loaded at operation S10.

If it is determined at operation S15 that the scanned document is not the first page, the controller 180 determines in operation S16 whether the orientation recognized at operation S14 with respect to the scanned second page is the same as that of the previous document, i.e. the first page.

If it is determined at operation S16 that the orientation is the same, the controller 180 determines in operation S18 the job corresponding to the second page as the consecutive job, i.e., job corresponding to the first job set at operation S11.

In operation S19, the controller 180 determines whether the document scanned at operation S13 is the last page of the documents loaded at operation S10.

If it is determined at operation S19 that the scanned document is not the last page, the controller 180 scans the third page of the documents loaded on the document feeder 110 and generates the image in operation S13.

In operation S14, controller 180 recognizes the orientation of the document by using the image generated at operation S13.

In operation S15, the controller 180 determines whether the document scanned at operation S13 is the first page of the documents loaded at operation S10.

If it is determined at operation S15 that the scanned document is not the third page, i.e., not the first page, the controller 180 determines in operation S16 whether the orientation recognized at operation S14 with respect to the scanned third page is the same as that of the previous document, i.e., the second page.

If it is determined at operation S16 that the orientation is changed, the controller 180 recognizes in operation S18 the job corresponding to the third page as a new job, i.e., the job corresponding to the second job set at operation S11.

In operation S19, the controller 180 determines whether the document scanned at operation S13 is the last page of the documents loaded at operation S10.

As above, the controller 180 sequentially performs the operations S14 to S17 or S13 to S18 for all of the documents loaded at operation S10.

The controller 180 determines whether the job corresponding to the last page of the documents loaded at operation S10 is a new job or a consecutive job. If it is determined at operation S19 that the concerned page is the last page, the controller 180 in operation S20 separately performs the multiple jobs corresponding to each page according to the determination made at operation S17 or S18.

The operation S20 may be performed at a time when the multiple jobs are separated, or may be performed sequentially starting from the first job upon completion of the separation.

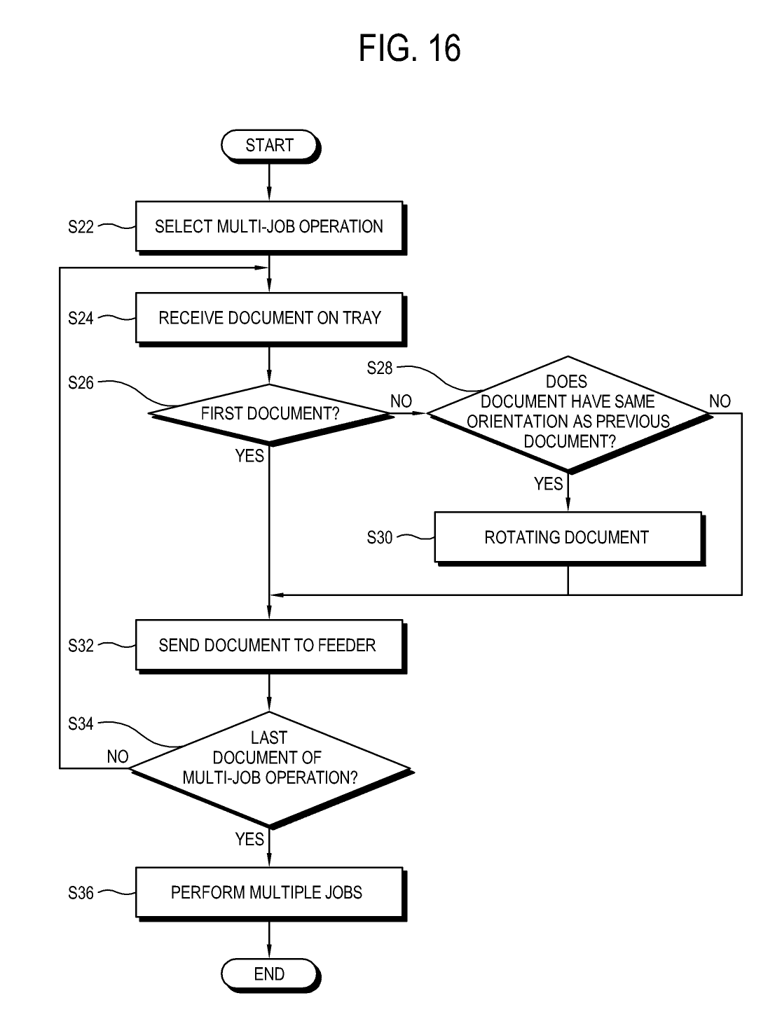

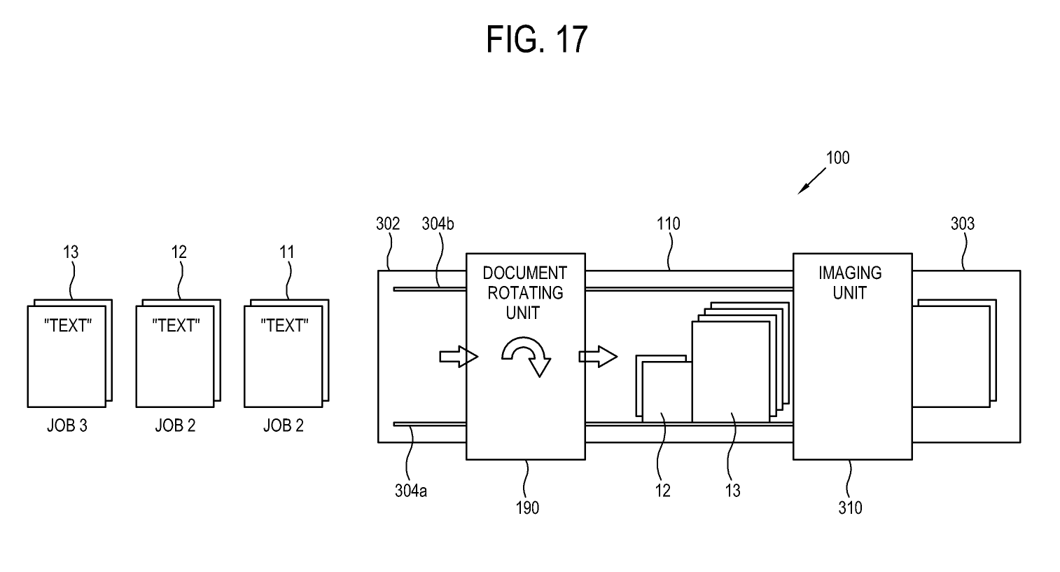

FIGS. 16 and 17 illustrate a method and apparatus to automatically rotate documents corresponding to separate jobs according to an embodiment of the present general inventive concept. A user may wish to submit a plurality of documents having the same orientation to the image forming apparatus 100, and to have the document rotation unit 190 of the image-forming apparatus 100 rotate the documents to the correct orientation.

In such a case, an image-forming apparatus 100 may include an input tray 302 including one or more guides 304a and 304b to align a document. In operation S22, a user may indicate to the image-forming apparatus 100 that a multi-job operation will be performed. The indication of the multi-job operation may be made via the user input unit 160 of the image-forming apparatus, as illustrated in FIG. 1A, or via the communication unit 140 connected to an external device. In operation S24, a user or device may place a document 11, 12, or 13 on the tray 302, and indicate to the image-forming apparatus 100. The image-forming apparatus 100 may determine in operation S26 whether the document is the first document of the multi-job operation. If so, the document rotation unit 190 may transmit the document to the feeder 110 in operation S32 without changing an orientation of the document.

However, if it is determined in operation S26 that the document on the tray 302 is not the first document, the image-forming apparatus 100 may determine in operation S28 whether the orientation of a present page is the same as an orientation of a page of the previous document, and the document rotation unit 190 may rotate the document in operation S30 to have the correct page or text orientation. For example, a user may input a first document 11 onto the tray 302, and the image-forming apparatus may transmit the first document 11 to the feeder 110 without rotating the document. The user may then place a second document 12 onto the feeder 12. If the orientation of a predetermined page, e.g. the top page, of the second document 12 is the same as that of the previous document, the document rotation unit 190 may rotate the document to the correct orientation to be separated into multiple jobs in a multi-job operation. Alternatively, if the second document has been rotated with respect to the first document 11, but the second document 12 has been rotated incorrectly (such as over-rotated or under-rotated), the document rotation unit 190 may correctly rotate the second document 12.

Once the image-forming apparatus 100 has determined in operation S34 that all the documents of a multi-job operation have been received and correctly rotated, the controller 180 of the image-forming apparatus 100 may transmit the documents 11, 12, and 13 corresponding to the respective jobs 1, 2, and 3 to the imaging unit 310 to be imaged and to perform the jobs 1, 2, and 3. The imaging unit 310 may include the image scanner 120, the image-forming unit 130, the storage unit 150, the communication unit 140, and the controller 180 of FIG. 1A, for example.

Upon completion of the multi-job operation, the image-forming apparatus 100 may output the documents 11, 12, and 13 to the output tray 303. The documents may be rotated to have a same orientation or a different orientation, depending on a user preference. By utilizing a document rotating unit 190 as illustrated in FIGS. 1B and 17, user errors of incorrect document rotations may be prevented, for example.

Accordingly, the image forming apparatus 100 according to the present general inventive concept may separately perform multiple jobs in a multi-job operation mode according to the recognized orientation of the document.

Accordingly, the image forming apparatus 100 according to the present general inventive concept may easily separate multiple jobs without an additional prior operation and has less error by using an orientation of a document.

As described above, an image forming apparatus and a multi-job performing method thereof according to the present general inventive concept separately performs multiple jobs by using an orientation of a document loaded to a paper without an additional prior operation.

Also, the image forming apparatus and the multi-job performing method thereof according to the present general inventive concept uses an orientation of a document in separating jobs and has less error than using a separate page.

Although a few exemplary embodiments of the present general inventive concept, have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A multi-job operation method of an image forming apparatus including a document feeder and an operation panel to configure a job, the method comprising:
loading a plurality of documents on the document feeder, the documents having an orientation that is different with respect to each adjacent document;
using the operation panel to select a multi-job operation, each job of the multi-job operation corresponding to a respective document on the document feeder;
scanning the plurality of documents;
determining a job corresponding to each of the documents based on an orientation of each of the scanned documents; and
performing different operations on the scanned documents corresponding to each job.

2. The method according to claim 1, wherein determining the job corresponding to each of the documents comprises determining a width and a height of the scanned documents.

3. The method according to claim 1, wherein determining the job corresponding to each of the documents comprises recognizing a job as the same as a previous job if the orientation of a scanned document is from the same as that of the previous document.

4. The method according to claim 1, wherein determining the job corresponding to each of the documents comprises recognizing an orientation of a text by using an optical character recognition (OCR) on the scanned document, and
separating the job according to the recognized orientation of the text.

5. The method according to claim 1, wherein determining the job corresponding to each of the documents comprises setting each job option for each orientation of the documents.

6. The method according to claim 1, further comprising displaying the multi-job operation result on the operation panel.

7. The method according to claim 1, wherein the performing the multi-job operation comprises:
comparing the number of separated documents and the number of set job options; and
notifying a user of a difference between the number of separated documents and the number of set job options.

8. The method according to claim 7, wherein the performing the multi jobs further comprises:
revising one of the number of documents and the number of set job options if there is a difference therebetween.

9. The method according to claim 1, wherein the performing the multi-job operation comprises:
revising a set job option if a job having the set job option is yet to be performed.

10. The method according to claim 1, wherein the job comprises at least one of copy, fax, scan-to-email, scan-to-host, scan-to-server, scan-to-HDD, and scan-to-USB jobs.

11. An image forming apparatus connected with an external device, the image forming apparatus comprising:
a document feeder to separately load a plurality of documents, each document having an orientation different from each adjacent document;
an image scanner to scan the loaded documents;
an operation panel including a display panel including a touch panel to select a multi-job operation mode and a user input unit to set a multi-job option in the multi-job operation mode by using the touch panel of the display unit; and
a controller to control the image scanner to scan the loaded documents, to separate the documents in to multiple jobs of the multi-job operation according to the orientation of the scanned documents, and to perform the multiple jobs according to the multi-job options corresponding to the separated jobs.

12. The image forming apparatus according to claim 11, wherein the controller separates the multiple jobs based on a width and a height of the scanned documents.

13. The image forming apparatus according to claim 11, wherein the controller recognizes a job as the same as that of a previous document if the orientation of a scanned document is the same as that of a previous document.

14. The image forming apparatus according to claim 11, wherein the controller recognizes an orientation of a text by using an optical character recognition (OCR) with respect to the scanned documents, and
the controller separates the jobs based on the recognized orientation of the text.

15. The image forming apparatus according to claim 11, wherein the operation panel is used to set each job option for each orientation of the document.

16. The image forming apparatus according to claim 11, wherein the operation panel displays a result of the multi-job operation.

17. The image forming apparatus according to claim 11, wherein the controller compares the number of the separated jobs and the number of set job options, and controls the operation panel to notify a user of a difference between the number of the separated jobs and the number of the set job options.

18. The image forming apparatus according to claim 17, wherein if there is difference between the number of the separated jobs and the number of the set job options, one of the number of the jobs and the number of the job options is revised according to a user's selection.

19. The image forming apparatus according to claim 11, wherein if the job having the job option set is yet to be performed, the set job option is revisable.

20. The image forming apparatus according to claim 11, further comprising:
a communication unit including at least one of a fax communication module to transmit the scanned document by fax, a network communication module to communicate with an external device, or an interface which is compatible with a hard disk drive (HDD) or a universal serial bus (USB),
wherein the job comprises at least one of copy, fax, scan-to-email, scan-to-host, scan-to-server, scan-to-HDD and scan-to-USB jobs.
